(19) United States
(12) Patent Application Publication
(10) Pub. No.: US 2010/0149637 A1
(43) Pub. Date: Jun. 17, 2010

(54) OPTICAL FILTER AND PLASMA DISPLAY HAVING THE SAME

(76) Inventors: Do-Hyuk Kwon, Suwon-si (KR); Sung-Yong Lee, Suwon-si (KR); Cha-Won Hwang, Suwon-si (KR); Sang-Mi Lee, Suwon-sI (KR); Seung-Goo Baek, Suwon-si (KR)

Correspondence Address: CHRISTIE, PARKER & HALE, LLP, PO BOX 7068, PASADENA, CA, 91109-7068, US

(21) Appl. No.: 12/624,164

(22) Filed: Nov. 23, 2009

(30) Foreign Application Priority Data
Dec. 15, 2008 (KR) 10-2008-0127115

(51) Int. Cl. G02B 5/28; G02B 5/30; G02B 1/11

(52) U.S. Cl. 359/493; 359/580

(57) ABSTRACT

An optical filter including: a polarizing film; and a plurality of phase delay films laminated on one side of the polarizing film, the optical axes of the phase delay films crossing each other, the plurality of phase delay films phase-delaying light having wavelengths in the visible range incident through the polarizing film and phase-delaying light reflected from a surface, thereby allowing the incident light to be interfered with and offset by the reflected light.

### CROSS-REFERENCE TO RELATED APPLICATIONS

This application claims priority to and the benefit of Korean Patent Application No. 10-2008-0127115, filed on Dec. 15, 2008, in the Korean Intellectual Property Office, the entire content of which is incorporated herein by reference.

### BACKGROUND OF THE INVENTION

1. Field of the Invention

An aspect of the present invention relates to an optical filter capable of improving a bright room contrast ratio of a plasma display device and a plasma display device having the same.

2. Description of Related Art

A PDP generally includes a display panel, a driving circuit and a case. The display panel includes a pair of substrates opposite to each other, an electrode group disposed between the substrates, an insulator electrically insulating electrodes in the electrode group from each other, barrier ribs forming a discharge space, and phosphors disposed in the discharge space. The driving circuit processes image signals received from outside of the PDP and supplies the received image signals to the electrode group, thereby driving the display panel. The PDP may refer to a display panel itself or a plasma display device including the display panel, the driving circuit, the case and the like.

Plasma display devices have relatively higher luminance loss due to external light reflection than other display devices such as CRTs.

To solve such a problem, a method is widely used in which an optical filter provided with black stripes having a predetermined height and a predetermined pitch is disposed on the front of a plasma display device, thereby improving a bright room contrast ratio of the plasma display device.

However, it is difficult to manufacture an optical film provided with a black stripe structure of a specific pattern. Further, when the aforementioned optical filter is disposed on the front of a plasma display device, about 30% of light emitted from the plasma display device is shielded by the optical film, and therefore, luminance is lowered.

To reduce external light reflection of a plasma display device, an anti-reflection layer is formed in a conventional optical filter.

However, in the anti-reflection layer only including high and low refractive layers, therefore it is difficult to effectively shield external light.

### SUMMARY OF THE INVENTION

Accordingly, exemplary embodiments of the present invention provides an optical filter capable of improving a bright room contrast ratio of a plasma display device by improving an external light-shielding property.

The present invention also provides a plasma display device having the aforementioned optical filter.

An embodiment of the present invention provides an optical filter including: a polarizing film; and a plurality of phase delay films laminated on one side of the polarizing film, the optical axes of the phase delay films crossing each other, the plurality of phase delay films phase-delaying light having wavelengths in the visible range incident through the polarizing film and phase-delaying light reflected from a surface, thereby allowing the incident light to be interfered with and offset by the reflected light.

The plurality of phase delay films may include first, second and third phase delay films.

Each of the first to third phase delay films may include a film body having a pattern.

The pattern may include a plurality of convex lines extending in one direction and a plurality of concave lines positioned between the plurality of convex lines.

The optical axes may correspond to the direction in which the convex and concave lines of the patterns extend.

The crossing angle between the optical axes of the first and second phase delay films may be about 45 degrees, and the crossing angle between the optical axes of the first and third phase delay films may be about 45 degrees.

Each of the plurality of phase delay films may be horizontally oriented so that a major axis direction of liquid crystal molecules adjacent to each of the plurality of phase delay films is parallel with the direction in which the convex and concave lines of the patterns extend in the state of no electric field.

Another embodiment of the present invention provides a plasma display device including: a plasma display panel; and an optical filter on one surface of the plasma display panel, the optical filter including a polarizing film; and a plurality of phase delay films laminated on one side of the polarizing film, the optical axes of the phase delay films crossing each other, the plurality of phase delay films phase-delaying light having wavelengths in the visible range incident through the polarizing film and phase-delaying light reflected from a surface, thereby allowing the incident light to be interfered and offset by the reflected light.

The plasma display device may further include a driving device driving the plasma display panel.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic cross-sectional view of an optical filter according to an embodiment of the present invention.

FIG. 2 is an exploded perspective view of a phase delay film for the optical filter according to the embodiment of the present invention.

FIG. 3 illustrates a process of reflecting and attenuating external light in the optical filter according to the embodiment of the present invention.

FIG. 4 is a graph illustrating an operation of the phase delay film in the optical filter according to the embodiment of the present invention.

FIG. 5 is a partial exploded perspective view of a plasma display device according to an embodiment of the present invention.

### DETAILED DESCRIPTION OF EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Here, the another element may refer to a hard coating layer, a conductive thin film for shielding electromagnetic waves, a color correction layer or a combination thereof, which is used in an optical filter. In the drawings, the thickness or size of each layer may be exaggerated for the convenience and clarity of description. Hereinafter, like reference numerals refer to like elements.

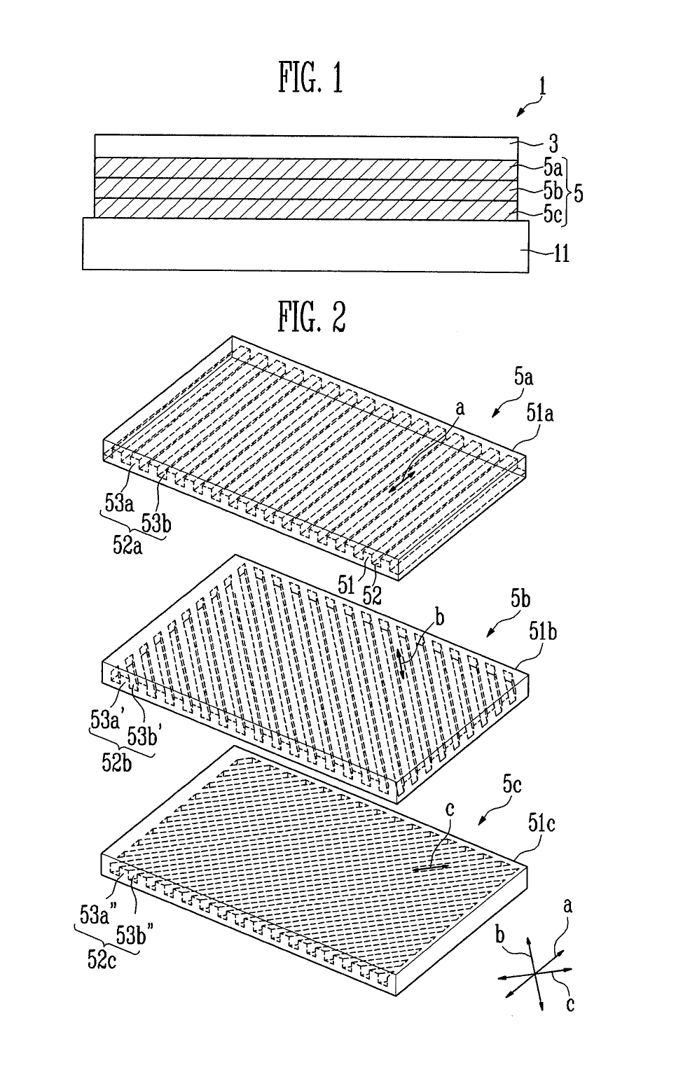

FIG. 1 is a schematic cross-sectional view of an optical filter according to an embodiment of the present invention. FIG. 2 is an exploded perspective view of a phase delay film for the optical filter according to the embodiment of the present invention.

Referring to FIG. 1, the optical filter 1 according to an embodiment of the present invention includes a polarizing film 3 and a phase delay film 5 laminated on one surface of the polarizing film 3.

Polarization refers to a phenomenon in which when electromagnetic waves propagate through space, an electric or magnetic field forming the waves is vibrated in a specific direction. The polarizing film 3 allows part of the light to pass therethrough, the part of light vibrating in a specific direction among the light incident onto one surface of the optical filter.

The polarizing film 3 may be formed by adsorbing iodine or dye on a polyvinyl alcohol (PVA) film and then stretching the film. In this case, the polarizing film 3 divides incident light into two types of polarized light components orthogonal to each other. The polarizing film 3 absorbs or disburses one component and allows only the other component to pass therethrough.

The phase delay film 5 is also referred to as a retardation film and includes a plurality of retardation films 5a, 5b and 5c. Third, second and first retardation films 5c, 5b and 5a are sequentially on a transparent substrate 11 disposed on the front of a plasma display device. The transparent substrate 11 may be a front substrate of a plasma display panel (PDP).

In this embodiment, three sheets of retardation films 5a, 5b and 5c having optical axes crossing each other are laminated so that external light with wavelengths in the visible range incident from the outside are interfered and offset by light reflected on the front substrate of the PDP regardless of delays of the wavelengths.

For example, as shown in FIG. 2, the first retardation film 5a includes a film body 51a and an irregular pattern 52a buried in the film body 51a. The irregular pattern 52a of the first retardation film 5a includes a plurality of convex lines 53a extending in a first direction “a” and a plurality of concave lines 53b positioned between the convex lines 53a. Similarly, the second retardation film 5b includes a film body 51b and an irregular pattern 52b buried in the film body 51b. The irregular pattern 52b of the second retardation film 5b includes a plurality of convex lines 53a′ extending in a second direction “b” and a plurality of concave lines 53b′ positioned between the convex lines 53a′. In addition, the third retardation film 5c includes a film body 51c and an irregular pattern 52c buried in the film body 51c. The irregular pattern 52c of the third retardation film 5c includes a plurality of convex lines 53a″ extending in a third direction “c” and a plurality of concave lines 53b″ positioned between the convex lines 53a″.

The optical axes of the first to third retardation films 5a, 5b and 5c correspond to the directions in which convex and concave lines of the irregular patterns extend, respectively. The crossing angle between the optical axes a and b of the first and second retardation films 5a and 5b may be about 45 degrees, and the crossing angle between the optical axes a and c of the first and third retardation films 5a and 5c may be about 45 degrees. That is, the irregular pattern 52b of the second retardation film 5b may be obtained by rotating the irregular pattern 52a of the first retardation film 5a by about 45 degrees counterclockwise, and the irregular pattern 52c of the third retardation film 5c may be obtained by rotating the irregular pattern 52a of the first retardation film 5a by about 45 degrees clockwise.

Each of the first to third retardation films 5a, 5b and 5c may be horizontally oriented so that a major axis direction of liquid crystal molecules to be disposed adjacent to each of the first to third retardation films 5a, 5b and 5c is parallel with the direction in which convex and concave lines of each of the irregular patterns extend in the state that an electric field is not applied (electric field absence).

The heights and widths of the convex and concave lines 53a, 53b (53a′, 53b′ or 53a″, 53b″) of each of the irregular patterns are determined depending on a material or thickness of each of the retardation films. The size of the convex lines 53a (53a′, 53a″) and/or the size of the concave lines 53b (53b′, 53b″) in each of the retardation films may be formed differently from each other so that different wavelengths in the visible range can be delayed. For example, each of the irregular patterns may be formed to have a phase difference of ¼ wavelength.

FIG. 3 illustrates an operational principle of the optical filter according to the embodiment of the present invention.

Generally, light is in a state where rays vibrating in all directions are mixed. However, for convenience of illustration, this embodiment will be described in reference to light having two polarized directions.

As shown in FIG. 3, part S of the external light incident onto the optical filter 1 is shielded by the polarizing film 3, and only a ray P1 (hereinafter, referred to as a first ray) of part P of the external light incident onto the optical filter 1 having a specific polarization passes through the polarizing film 3. The first ray P1 is delayed by a phase (e.g., a predetermined phase) while passing through the phase delay film 5. The first ray P1 delayed by the phase is referred to as a second ray P2. The second ray P2 is reflected on one surface of the glass substrate 11. A third ray P3 reflected on the one surface of the glass substrate 11 is again delayed by a phase (e.g., a predetermined phase) while again passing through the phase delay film 5. The third ray P3 again delayed by the phase is referred to as a fourth ray P4. At this time, if the phase difference between the first and fourth rays P1 and P4 is ½ wavelength, the first ray P1 is attenuated by the fourth ray P4.

Although FIG. 3. shows the advancing direction of light, at least part of the light passing through the phase delay film 5 is practically not incident in a direction vertical to the one surface of the glass substrate 11, but is refracted with an inclination angle, e.g., an inclination angle of 45 degrees or more in a direction vertical to the one surface of the glass substrate 11 in the phase delay film 5, and then incident onto the one surface of the glass substrate 11 with the inclination angle at which the light is refracted. For this reason, the rays may be reflected on the other surface of the glass substrate 11. Accordingly, the second ray P2 includes a ray reflected on the other surface opposite to the one surface of the glass substrate 11. Here, the one and the other surfaces of the glass substrate 11 refer to two main surfaces opposite to each other in the plate-shaped glass substrate 11.

As described above, according to the embodiment of the present invention, the plurality of retardation films 5a, 5b and 5c are laminated so that their optical axes cross one another. Accordingly, all external light with wavelengths in the visible range selectively incident through the polarizing film can be interfered and offset by their reflected light regardless of delays of the wavelengths.

Only a first internal ray Pal of the internal light part Pa having a certain polarization passes through the polarizing film 3, and a second internal ray Sal of the internal light part Sa is shielded from passing to the outside.

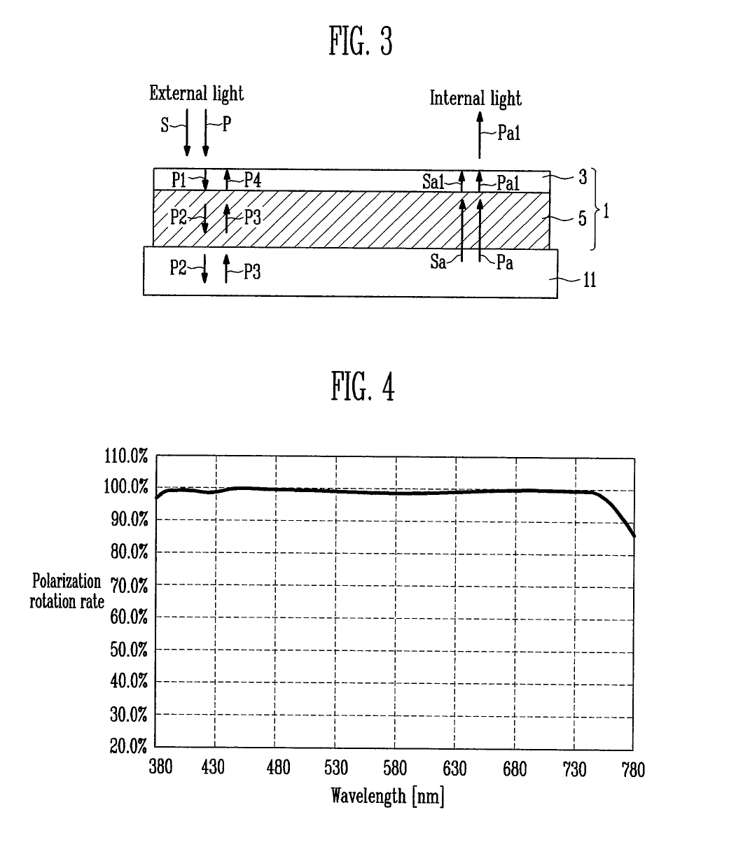

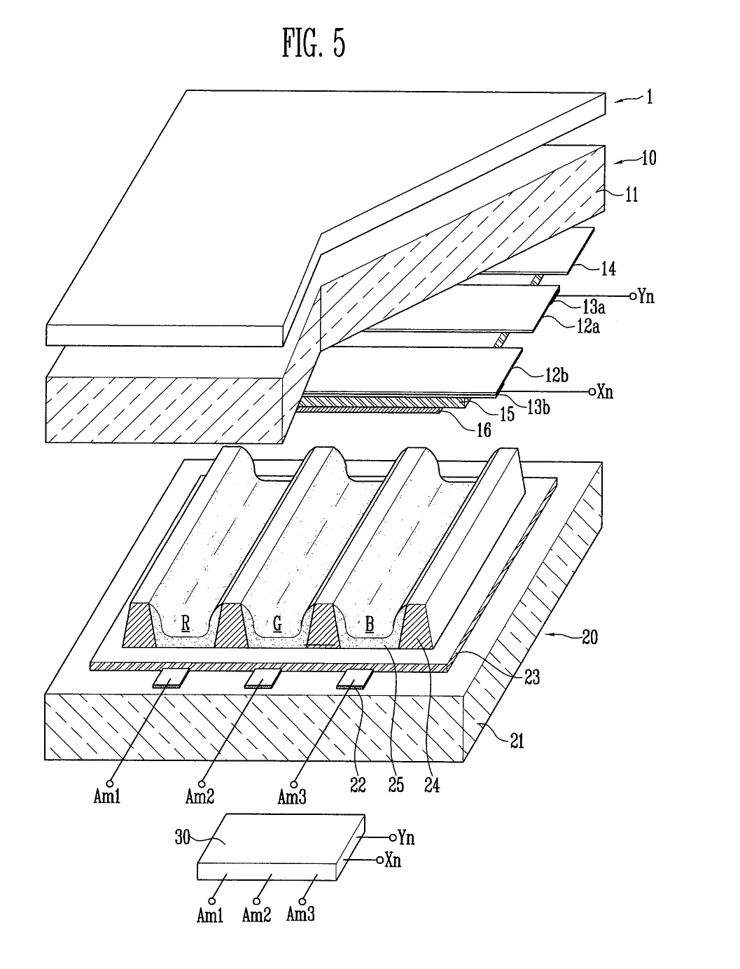

FIG. 4 is a graph illustrating an operation of the phase delay film in the optical filter according to the embodiment of the present invention.

As shown in FIG. 4, when using three sheets of phase delay films laminated so that their optical axes cross one another, polarized light can be rotated without delays of wavelengths in the visible range, i.e., about 400 to 700 nm.

In other words, the three sheets of phase delay films are formed so that their optical axes cross one another. Accordingly, the optical filter according to the embodiment of the present invention can allow all wavelengths in the visible range to be delayed by a desired phase without delays of wavelengths.

The optical filter according to an embodiment of the present invention may include an electromagnetic shielding layer and a color correction layer, disposed on one surface of the polarizing film 3, and a hard coating layer disposed on one surface of the electromagnetic shielding layer or the color correction layer. The color correction layer may include a dye and/or a pigment capable of absorbing light with a wavelength in a range of about 800 to 1100 nm. Alternatively, the color correction layer may include a dye and/or a pigment capable of absorbing light with a wavelength in a range of about 590 nm to improve color purity. The optical filter according to an embodiment of the present invention may further include an adhesive layer disposed on one surface of the phase delay film 5. The adhesive layer may be used to allow an optical filter to be adhered to a glass filter disposed at the front side of a plasma display device. In this case, the optical film may have a structure in which the adhesive layer, the phase delay film, the polarizing film, the electromagnetic shielding layer and the hard coating layer are sequentially laminated. The color correction layer may be formed together with the adhesive layer.

FIG. 5 is a partial exploded perspective view of a plasma display device according to an embodiment of the present invention.

Referring to FIG. 5, a PDP includes a display panel having an optical filter 1 and front and back plates 10 and 20 disposed opposite to each other, and a driving device 30 driving the display panel.

The optical filter 1 includes the optical filter according to the aforementioned embodiment of the present invention.

The driving device 30 processes image signals inputted from outside of the PDP and supplies the processed image signals to the display panel. For example, the driving device 30 may include an image processing unit, a sub-field control unit, a driving control unit and the like. In this case, the image processing unit may include a gamma corrector performing gamma correction with respect to the inputted image signals, a timing controller for timing control, and a frame frequency converter controlling frame frequencies, and the like. The sub-field controller converts image information for each unit frame into sub-field coding information based on gray levels determined by the image processing unit and supplies the converted sub-field coding information to an address driving unit. The driving controller generates driving signals based on the gray levels determined by the image processing unit and supplies the generated driving signals to a scan driving unit and a sustain driving unit.

The display panel displays an image, which may be predetermined, in response to driving signals and data signals. Here, the driving signals are supplied through scan and sustain electrodes Yn and Xn from the scan and sustain driving units of the driving device 30, respectively. The data signals are supplied through address electrodes Am1, Am2 and Am3 from the address driving unit of the driving device 30. The respective components of the display panel will be described in detail as follows.

The front plate 10 includes transparent electrodes 12a and 12b, bus electrodes 13a and 13b, a black layer 14, a first dielectric layer 15 and a passivation layer 16, which are formed on a first substrate 11. The lower plate 20 includes address electrodes 22, a second dielectric layer 23, barrier ribs 24 and phosphor layers 25, which are formed on the second substrate 21. The PDP may include a sealing member that joins the upper and lower plates 10 and 20 together.

The first substrate 11 includes a transparent glass substrate. The second substrate 21 includes not only an opaque glass substrate but also all available substrates, in addition to the transparent glass substrate.

The transparent electrodes 12a and 12b are used to generate and maintain electric discharge. The transparent electrodes 12a and 12b may be formed of a transparent material having high visible light transmittance, e.g., ITO, SnO₂, ZnO, CdSnO or the like.

The bus electrodes 13a and 13b are used to compensate for the high resistance of the transparent electrodes 12a and 12b. The bus electrodes 13a and 13b are disposed to have a narrower width than that of the transparent electrodes 12a and 12b. The bus electrodes 13a and 13b are formed of a material which has low electric resistance and does not react to the first dielectric layer 15. The material of the bus electrodes 13a and 13b may include gold (Au), silver (Ag) and the like.

The respective pairs of one transparent electrode 12a and one bus electrode 13a and the other transparent electrode 12b and the other bus electrode 13b constitute X-Y electrodes.

The black layer 14 may be selectively disposed between one X-Y electrode and another X-Y electrode adjacent to the one X-Y electrode so as to improve a contrast ratio. The black layer 14 is formed of a material having very low visible light transmittance and high external light absorptance.

The first dielectric layer 15 limits discharge current, maintains glow discharge and accumulates wall charges. The first dielectric layer 15 may be formed of a material having high withstanding voltage and high visible light transmittance. The material of the first dielectric layer 15 may include PbO—B₂O₃—SiO₂ system, Bi₂O₃ system or the like. The first dielectric layer 15 is typically formed into a double-layered structure to have a uniform surface and at least a certain thickness. However, the first dielectric layer 15 may be formed into a single- or multiple-layered structure using a printing technique.

The passivation layer 16 is disposed on the first dielectric layer 15 to protect the first dielectric layer 15 from ion collision and to increase a secondary electron emission coefficient. The passivation layer 16 may be formed of a material having high visible light transmittance, a high surface insulating property and excellent resistance for ion sputtering through a thin film deposition technique. The material of passivation layer 16 may include MgO and the like.

The address electrodes 22 are electrodes used to select discharge cells, and are disposed in a stripe shape on the second substrate. At this time, the stripe-shaped address electrodes 22 are extended to be roughly perpendicular to the transparent electrodes 12a and 12b. The address electrodes 22 are formed of a material having high electrical conductivity, e.g., gold (Au), silver (Ag) or the like, through a printing technique.

The second dielectric layer 23 is disposed on the second substrate 21 to protect the address electrodes 22 and to have high dielectric strength. The second dielectric layer 23 may be formed of a material having high light reflectance or colored with a material capable of increasing light reflectance. The material of the second dielectric layer 23 may include PbO, SiO₂, B₂O₃ and the like.

The barrier ribs 24 are disposed to prevent a discharge cell region from extending in a lateral direction of the transparent electrodes 12a and 12b, to increase color purity by preventing color mixture of visible light, and to have a strength on which the front plate 10 can be supported. In one embodiment, the barrier ribs should 24 have a width as narrow as possible and a height as appropriately high as possible so that a large number of discharge spaces are formed in a limited region. The barrier ribs 24 may be formed of a material having a dense texture to prevent or reduce organic matter absorption caused by a phosphor paste. The material of the barrier rib 24 may include PbO, SiO₂, B₂O₃, etc.

The phosphor layers 25 convert ultraviolet light generated by discharge into visible light and emit the converted light. The phosphor layers 25 are formed of a material having high light conversion efficiency and high color purity. The phosphor layers 25 include red (R), green (G) and blue (B) phosphor layers.

According to the aforementioned plasma display device, the optical filter 1 disposed on one surface of the first substrate 11 of the front plate 10 is utilized so that external light is offset due to the interference phenomenon, and internal light is radiated to the outside. Accordingly, a bright room contrast ratio of the plasma display device can be improved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An optical filter comprising:
a polarizing film; and
a plurality of phase delay films laminated on one side of the polarizing film, the optical axes of the phase delay films crossing each other, the plurality of phase delay films phase-delaying light having wavelengths in the visible range incident through the polarizing film and phase-delaying light reflected from a surface, thereby allowing the incident light to be interfered with and offset by the reflected light.

2. The optical filter of claim 1, wherein the plurality of phase delay films comprises first, second and third phase delay films.

3. The optical filter of claim 2, wherein each of the first to third phase delay films comprises a film body having a pattern.

4. The optical filter of claim 3, wherein the pattern comprises a plurality of convex lines extending in one direction and a plurality of concave lines positioned between the plurality of convex lines.

5. The optical filter of claim 4, wherein the optical axes correspond to the direction in which the convex and concave lines of the patterns extend.

6. The optical filter of claim 5, wherein the crossing angle between the optical axes of the first and second phase delay films is about 45 degrees, and the crossing angle between the optical axes of the first and third phase delay films is about 45 degrees.

7. The optical filter of claim 4, wherein each of the plurality of phase delay films is horizontally oriented so that a major axis direction of liquid crystal molecules adjacent to each of the plurality of phase delay films is parallel with the direction in which the convex and concave lines of the patterns extend in the state of no electric field.

8. A plasma display device comprising:
a plasma display panel; and
an optical filter on one surface of the plasma display panel,
the optical filter comprising a polarizing film; and a plurality of phase delay films laminated on one side of the polarizing film, the optical axes of the phase delay films crossing each other, the plurality of phase delay films phase-delaying light having wavelengths in the visible range incident through the polarizing film and phase-delaying light reflected from a surface, thereby allowing the incident light to be interfered and offset by the reflected light.

9. The plasma display device of claim 8, wherein the plurality of phase delay films comprises first, second and third phase delay films.

10. The plasma display device of claim 9, wherein each of the first to third phase delay films comprises a film body having a pattern.

11. The plasma display device of claim 10, wherein the pattern comprises a plurality of convex lines extending in one direction and a plurality of concave lines positioned between the plurality of convex lines.

12. The plasma display device of claim 11, wherein the optical axes correspond to directions in which the convex and concave lines of the patterns extend.

13. The plasma display device of claim 12, wherein the crossing angle between the optical axes of the first and second phase delay films is about 45 degrees, and the crossing angle between the optical axes of the first and third phase delay films is about 45 degrees.

14. The plasma display device of claim 11, wherein each of the plurality of phase delay films is horizontally oriented so that a major axis direction of liquid crystal molecules adjacent to each of the plurality of phase delay films is parallel with the direction in which the convex and concave lines of the patterns extend in the state of no electric field.

15. The plasma display device of claim 8, further comprising a driving device driving the plasma display panel.
